(19) United States
(12) Patent Application Publication
(10) Pub. No.: US 2013/0132678 A1
(43) Pub. Date: May 23, 2013

(54) INFORMATION PROCESSING SYSTEM

(71) Applicant: FUJITSU LIMITED, Kawasaki-shi (JP)

(72) Inventors: Yuka Hosokawa, Ota (JP); Makoto Hataida, Yokohama (JP); Susumu Akiu, Kawasaki (JP); Daisuke Ito, Kawasaki (JP)

(73) Assignee: FUJITSU LIMITED, Kawasaki-shi (JP)

(21) Appl. No.: 13/738,433

(22) Filed: Jan. 10, 2013

Related U.S. Application Data
(63) Continuation of application No. PCT/JP2010/061785, filed on Jul. 12, 2010.

(51) Int. Cl. G06F 12/08

(52) U.S. Cl. CPC G06F 12/084
USPC 711/130

(57) ABSTRACT

An information processing system has a plurality of nodes which use a snoop cache memory in each of the plurality of nodes. A directory, which maintains a cache coherence of the snoop cache memory of the plurality of nodes, has a first directory and a second directory which has a different format from a format of the first directory and is only used for a shared state. The node searches the first and second directories, and determines the other node to transmit a snoop.

### CROSS-REFERENCE TO RELATED APPLICATION

This application is a continuation application of International Application PCT/JP2010/061785 filed on Jul. 12, 2010 and designated the U.S., the entire contents of which are incorporated herein by reference.

### FIELD

The embodiments discussed herein are related to an information processing system.

### BACKGROUND

It is effective in a high-speed parallel processing that an information processing system is constituted of a plurality of nodes connected to each other. By parallel computer has a distributed shared memory, it is possible to perform high-speed parallel computation. Each node of the information processing system includes an arithmetic processing unit (hereinafter, called as CPU (Central Processing Unit)) and a cache memory, etc. The information processing system utilizes the cache memory of each node as the distributed shared memory.

In the distributed shared memory which utilizes the cache memory, since the plurality of nodes share each of the cache memory, it is necessary to control the consistency of the cache memory. The consistency control is a control to maintain the cache coherence. A snoop cache is effective to maintain the cache coherence.

In the snoop cache function, when the CPU of one node performs writing data held in the own cache memory, the another node receives the write data via a shared bus and updates the data in the cache memory of another node. A directory system is utilized as a hardware mechanism to maintain the cache coherence. The directory system holds information indicating which CPU cached the same data in the cache memory, and performs invalidation and updating of the cache line.

A cache management system by the directory registers information that can identify a destination of snoop, such as status, node (board) identifier (ID: Identification), and CPU identifier (ID) in the node (board), when dispatching a request such as a read to one address of the memory request.

FIG. 11 and FIG. 12 are block diagrams of a conventional directory. And FIG. 11 depicts an entry format that the format type 101 in the directory 100 indicates a A-type (bit “1”). As depicted by FIG. 11, the entry format in the directory 100 has a format type field 101 of the entry, a reserved bit field 102, a status field 103, CPU-ID (1) field 104, and CPU-ID (2) field 105.

The status field 103 indicates a holding status of the data such as an exclusive state (Exclusive), an invalid state (Invalid), and shared status (Shared) with on or two CPU 103. The exclusive state indicates that requestor CPU performs an exclusive control (for example, a state after reading before updating). The invalid state indicates that any CPU is not holding the data. The shared state indicates that a plurality of the CPUs share the data. The CPU-ID fields 104 and 105 is stored the CPU-ID (Identification) that requested (called as a requestor).

FIG. 12 depicts an entry format that the format type 106 in the directory 100 indicates a B-type (bit “1”). The status field 107 indicates an exclusive state (Exclusive), an invalid state (Invalid), and shared status (Shared) with a plurality of CPUs. A bitmap field 108 of the board (node) is stored the board (node) of the CPU (called as a requestor) that requested in bitmap format.

For example, when the CPU requests (read requests) the data with the exclusive state (hereinafter referred to as E-state) such as for updating the data, the directory 100 is retrieved with the request address, and the data holding status is determined. When the retrieval of the directory results the data of the request address holds with the shared state (hereinafter referred to as S-state), a snoop is sent to the CPU which holds the data, and the data is updated to the invalid state (hereinafter referred to as I-state). Further, when the requested data is held in the exclusive state, a snoop is sent to the CPU that holds the data, and the corresponding data is updated to the invalid state (I: Invalid state).

In addition, when the CPU requests (read requests) the data with the shared state (S state), the directory 100 is retrieved with the request address, and the data holding status is determined. When the retrieval of the directory results the data of the request address holds with the exclusive state (E-state), a snoop to change the state of the data is sent to the CPU which holds the data. And when the retrieval of the directory results the data of the request address holds with the shared state (S-state), a snoop is sent to the CPU which holds the data, and the requestor CPU-ID is registered in the directory.

Here, the directory format field in FIG. 11 is set the A-type (format type bit is “1”) is set A-Type. The format type A-Type is an entry format that stores an identifier (ID) of the CPU. In the example of FIG. 11, the entry format can be stored up to two CPU-ID. On the other hand, the directory format field in FIG. 12 is set the B-Type (the format type bit is “0”). Format The format type B is a type that stores the CPU-ID in bitmap. In this case, the type can identify up to twelve nodes or CPUs.

In this way, when the CPU to be registered is more than two, the entry format in the directory 100 is changed A type (as depicted by FIG. 11) to B type (as depicted by FIG. 12) to store up to 12 nodes (or CPUs).

### RELATED ART

Japanese Laid-open Patent Publication No. 2001-101148

Japanese Laid-open Patent Publication No. 2005-044342

Recently, as a large-scale of the information processing system, single node (board) mounts a plurality of CPUs, and the number of system node (board) which is able to connect increases. For this reason, the number of node (or CPU), in which the directory of one node manages, increases.

The amount of information, in which the directory can hold, is a limit to the physical. When the number of nodes or CPUs to hold the data with the shared state (S-state) is increasing, the directory can not store the detailed information to identify the CPU of the snoop destination, because the entry size of the directory mechanism directory is limited.

For example, when three or more CPUs, which hold the data with the shared state, has occurred, the information of the CPU is held by the entry format of B-Type in FIG. 11, because the entry format of A type in FIG. 11 is not able to hold the information of three or more CPUs. However, even in the entry format of B-Type, the number of the CPU that can hold is up to 12. Therefore, even using the entry format of B-Type, when the information processing system mounts more than 13 CPUs, it is difficult to hold the CPU to be registered.

Further, in the entry format of B-Type, by changing the holding information to an upper hardware than the CPU, it is possible to increase the number of CPU in question. That is, the CPU is held by only ID of each unit (for example, board ID, which is a unit of the system board). For example, when holding the information on a per system board, it is difficult to identify the CPU in the system board.

Therefore, it is necessary to send the snoop to all the CPUs in the system board, it is difficult to sufficiently focus the snoop destination. In this way, when the CPUs or the nodes, which hold the data in S state, increases, it is necessary that the snoop is dispatches to all CPUs in the system board at a time of dispatching of the request, because the CPU itself can not be identified. As a result, because the amount of communication increases, a decrease in performance is caused.

### SUMMARY

According to an aspect of the embodiment, an information processing system includes a plurality of nodes, each of which includes at least single arithmetic processing unit, a cache memory that stores data in which the arithmetic processing unit utilizes, and a node controller that retrieves a directory which stores state information whether or not the data stored in the cache memory stores in the cache memory in another node and identification information of another node and communicates a snoop to another node. And the node controller includes a first directory which stores state information whether or not the data stored in the cache memory stores in the cache memory in another node and identification information of another node, and a second directory which stores information to identify shared nodes of the data in a shared state that the data stored in the cache memory stores in the cache memory in the other node.

The object and advantages of the invention will be realized and attained by means of the elements and combinations part particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a block diagram of an information processing system according to an embodiment;

FIG. 2 is a block diagram of a CPU in FIG. 1;

FIG. 3 is a block diagram of a node controller in FIG. 1;

FIG. 4 is an explanatory diagram of a directory in FIG. 3;

FIG. 5 is an explanatory diagram of an extension directory in FIG. 3;

FIG. 6 is a flow diagram of data request processing in S state according to the embodiment of FIG. 1 to FIG. 5;

FIG. 7 is a flow diagram of the data request processing in S state of comparative example of FIG. 6;

FIG. 8 is a flow diagram of the data request processing in E state according to the embodiment of FIG. 1 to FIG. 5;

FIG. 9 is a flow diagram of the data request processing in E state of comparative example of FIG. 8;

FIG. 10 is a block diagram of an information processing system according to a second embodiment;

FIG. 11 is an explanatory diagram of a conventional directory; and

FIG. 12 is an explanatory diagram of a conventional directory in S State.

### DESCRIPTIONS OF EMBODIMENTS

Hereinafter, the embodiments will be explained in a order of an information processing system according to a first embodiment, data request processing in S state, the data request processing in E state, the information processing system according to a second embodiment, and the other embodiment. However, the information processing system and the directory are not limited to these embodiments.

### First Embodiment of the Information Processing System

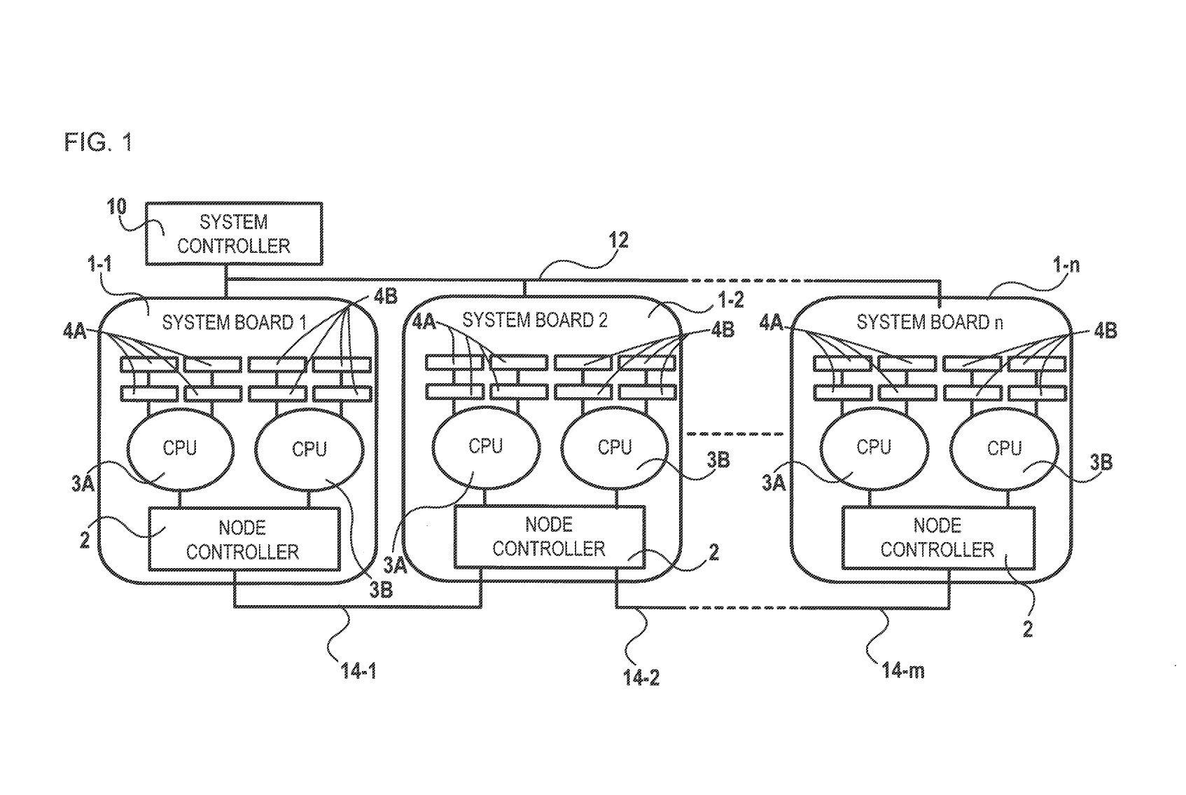

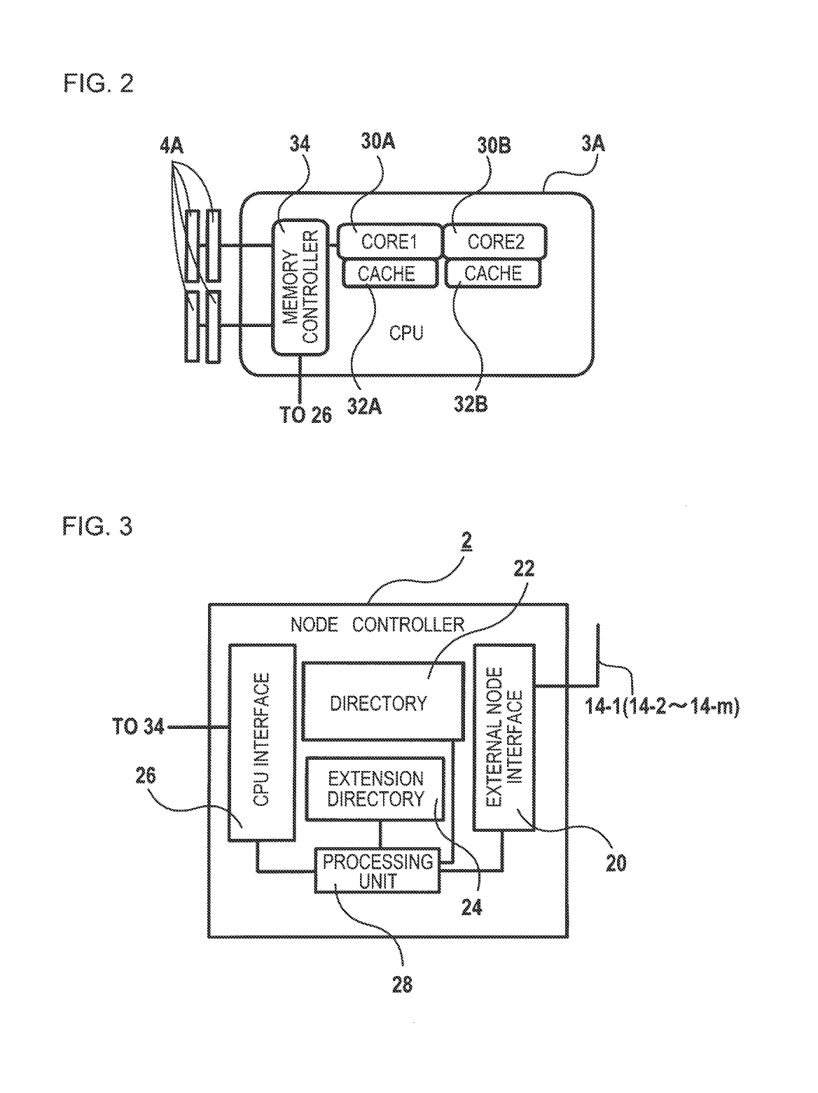

FIG. 1 is a block diagram of the information processing system according to a first embodiment. FIG. 2 is a block diagram of the CPU in FIG. 1. FIG. 3 is a block diagram of a node controller in FIG. 1. FIG. 1 illustrates an example of the information processing system in which a plurality of system boards have been concatenated. In the example, single system board is managed as a single node.

As depicted by FIG. 1, the information processing system has a plurality of system boards 1-1˜1-n (in this case, n>3). Each of the system boards 1-1˜1-n has a plurality of arithmetic processing units (referred to CPU: the Central Processing Unit as below) 3A and 3B (here, two in the embodiment), a plurality of memories 4A and 4B respectively connected to each of the CPUs 3A and 3B, and a node controller 2 that is connected to each of the CPUs 3A and 3B. For example, the memories 4A and 4B are configured to L2 and L3 cache memory. DIMM (Dual Inline Memory Module) is used to the memories 4A and 4B, for example. However, the memories may also be configured with other volatile memory.

As depicted by FIG. 2, the CPU 3A has two CPU cores 30A and 30B, two cache memories (L1 cache memory) 32A and 32B that are connected to each of the CPU cores 30A and 30B, and a memory controller 34 that connects the memory 4A with the CPU cores 30A and 30B and performs a memory access control. CPU 3B in FIG. 1 also has the same configuration as the CPU 3A.

Returning to FIG. 1, the node controller 2 communicates between the system boards 1-1˜1-n. In this example, the node controller 2 on the first system board 1-1 connects to the node controller 2 on the second system board 1-1 through a first communication path 14-1. In addition, the node controller 2 on the second system board 1-2 connects to the node controller 2 on the third system board 1-3 through a second communication path 14-2. Below, in the same way, the node controller 2 on the (n-1)th system board connects to the node controller 2 on the n-th system board via a (n-1) th communication path 14-m.

These communication paths 14-1˜14-m constitute a common bus. Instead of separate paths in FIG. 1, the communication paths 14-1˜14-m may be formed in the shared path.

The system controller 10 connects to each of the system boards 1-1˜1-n via a management bus 12. The system controller 10 performs a setting of status and monitoring of status of circuits (the CPU, the memory, etc.) on each of the system boards 1-1˜1-n. Furthermore, although not illustrated in FIG. 1, the main memory may be provided separately, and connects to each node.

As depicted by FIG. 3, the node controller 2 has an external node interface circuit 20 that communicates with the node controller on the other system board via the communication path 14-1, a CPU interface circuit 26 that communicates with the memory controller 34 of the CPUs 3A and 3B, a directory 22, a second directory 24, and a processing unit 28.

The processing unit 28 connects to the external node interface circuit 20, the CPU interface circuit 20, the directory 22, and the second directory 24. The processing unit 28 searches the directory 22 and the second directory 24, or the like, and transmits the snoop in response to the read/write request from the CPUs 3A and 3B and other nodes.

The node controller 2 utilizes the directory 22 to manage the data. The directory 22 stores the state of the data and management information which node holds same data within the address space of the cache memory in which the own node has.

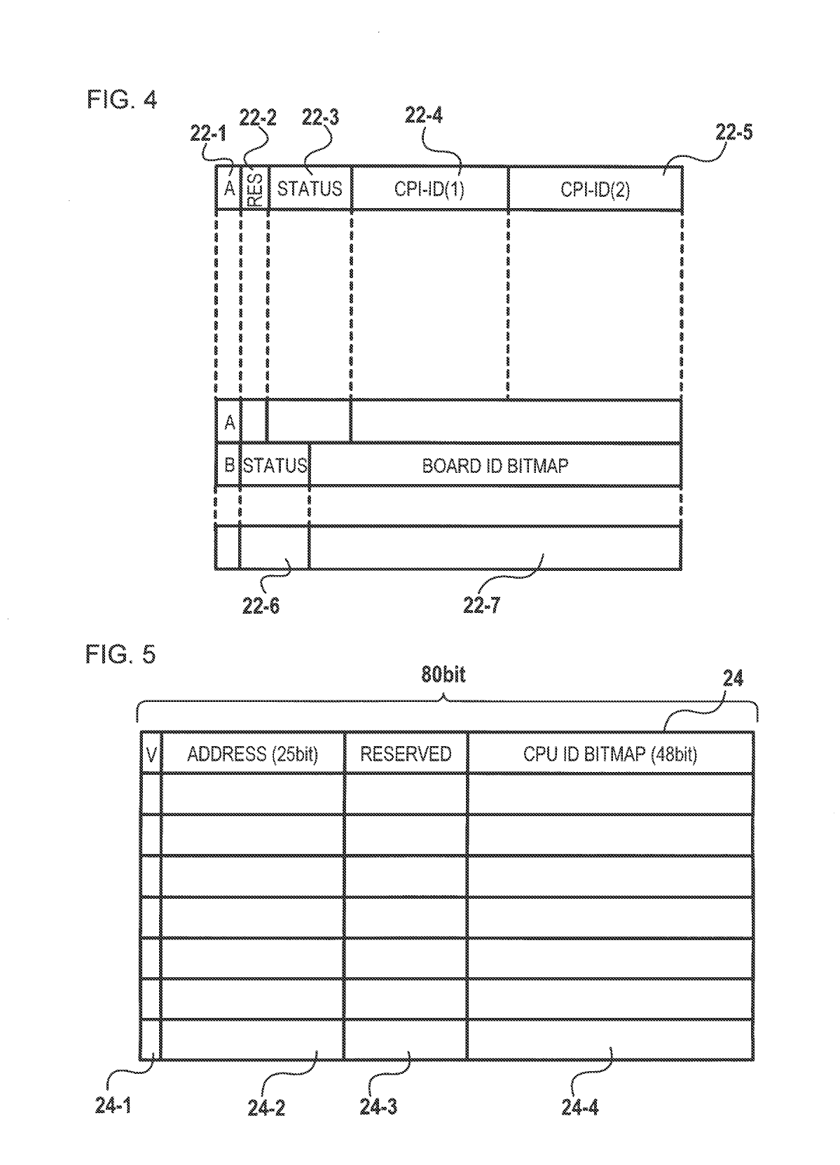

FIG. 4 is an explanatory diagram of the directory in FIG. 1 and FIG. 3. As indicated by FIG. 4, the directory 22 has an entry for each memory address of the L2, L3 cache memory in own node. For example, when the access unit of the CPU is 64 bit, the directory 22 has the number of entries with the result which is divided the capacity of the L2, L3 cache memories 4A and 4B in the own node by value “64”.

In this example, the width of one entry in the directory 22 is configured in 2 Byte (=16 bits). Further, the example of FIG. 4 indicates an example of mixing of the entries of the format type A and the entries of the format type B.

As depicted by FIG. 4, the entry format of the format type A includes the format type field 22-1 (A-type=1) of the entry, the reserve bit 22-2, the status field 22-3, a CPU-ID (1) field 22-4 (1), and a CPU-ID (2) field 22-5. The entry format of the format type B includes the format type field 22-1 (B-type=0) of the entry, a second status field 22-6, and board ID bitmap field 22-7.

The reserve bit field 22-2 is one bit of a spare bit. The status field 22-3 is composed of two bits. In the status field 22-3, the exclusive state (E state) is indicated by “10”, and the invalid state (I state) is indicated by “00” and the shared state with single CPU (S state) is indicated by “01”, and the shared state with two CPUs is indicated by “11”. The E state indicates that the CPU which requested (called to requester CPU) is in exclusive control. The I state indicates that any CPU do not hold the data. The S state indicates that a plurality of the CPU has shared the data.

The CPU-ID (1) field 22-4 (1) and the CPU-ID (2) field 22-5 of the format type A respectively store the CPU-ID of the CPU (requester) that dispatched the request CPU-ID. The CPU-ID fields 22-4 and 22-5 are composed of 6 bits each. The CPU-ID fields 22-4 and 22-5 store the board (system board) ID of 4 bits and the local ID (CPU-ID in the board) of 2-bits. Therefore, in this example, it can be identified that the number of nodes is up to 16 and the CPU in the node is up to four.

When more than three CPUs are shared state, the format type A is not utilized. When more than three CPUs are shared state, in the directory 22, the entry of the format type A is changed to the entry of the format type B. The second status field 22-6 of the format type B is composed of 3 bits, and set to “111” when three or more CPUs has shared. The board ID bitmap field is consists of 12 bits, and stores the board ID of the CPU (called requester) that was requested in bitmap format. In this example, the nodes can identify up to 12. However, the CPU in the node can not be specified. In other words, it is not possible to store the detail information per the CPU unit.

FIG. 5 is an explanatory diagram of the second directory in FIG. 1. The second directory (hereinafter referred to the extension directory) 24 is a directory to be used when it is no longer able to store more detail information in the directory 22.

The extension directory 24 is a dedicated directory that stores the detailed information to identify the CPU that holds the data in the shared state (S state) separately form the directory 22 in FIG. 4, when the CPU that holds data in the shared state (S state) has occurred more than a certain number (in this example, three or more CPUs). The extension directory 24 may be constructed by n-way type RAM (Random access memory) or full-associative type RAM.

The extension directory 24 has a valid bit field 24-1, memory address field 24-2, and reserve bit field 24-3, and a bitmap filed 24-4 of the CPU-ID. The valid bit field 24-1 is assigned to one bit. The valid bit field 24-1 indicates whether the entry in the extension field 24 is valid (Enable=“1”) or invalid (Disable=“0”).

The extension directory 24 is not be provided for each memory address, and only stores the detail information of the CPU that holds the data in the shared state (S state). Therefore, the extension directory 24 is provided with a memory address field 24-2. The memory address field 24-2 stores upper 25 bits except an index and a cache line in the memory address of shared state. The reserved bit field 24-3 is a spare bit. The bitmap field 24-4 of CPU-ID is composed of 48 bits. Each one bit in the bitmap field 24-4 identifies a single CPU. In this example, it is possible to identify forty eight number of the CPU. In this example, the entry width of the extension directory is 80 bits.

Thus, by setting the extension directory 24 with a format different from the format of the directory 22, it is possible to hold the detailed information of the CPU without increasing the entry width of the directory 22 as depicted by FIG. 4. Therefore, it is possible to issue the snoop which targets the destination by the information of a search result in the extension directory 24.

For example, when the information processing system has a cache memory of 1 Tera Byte, the memory capacity of memory of the directory 22 is a 32 Giga Byte, because each entry in the directory 22 is 2 Byte. When identifying forty-eight number of the CPUs by the entry format of the directory 22, it takes further 36-bit per one entry. Therefore, it is necessary to extend the entry width of the directory 22 beyond 6 Byte (to be precise, 6.5 Byte). For this reason, it is necessary to provide 96 Giga Byte of the directory 22 in order to identify more CPUs.

On the other hand, in the embodiment, since the extension directory 24 stores the data when three or more CPUs share the data, the extension directory 24 only have to target the data in the shared state in the directory 22. Further, in the information processing system, the probability to be shared state is lower than the probabilities of exclusion state and the invalid state. Therefore, it is sufficient that the capacity of the extension directory 23 is from a few Kiro Byte to 1 Mega Byte as a maximum. In other words, it is possible to provide same performance as the directory 22 of 96 Giga Byte by the directory 22 of 32 Giga Byte and the extension directory 24 up to 1 Mega Byte.

For this reason, it is possible to hold the detailed information of the CPU as a minimum increase in the amount of directory. In addition, since it is possible to minimize the number of snoop issuing by using the detailed information of the extension directory 24, it is possible to prevent an increase in traffic.

(Data Request Processing in the S State)

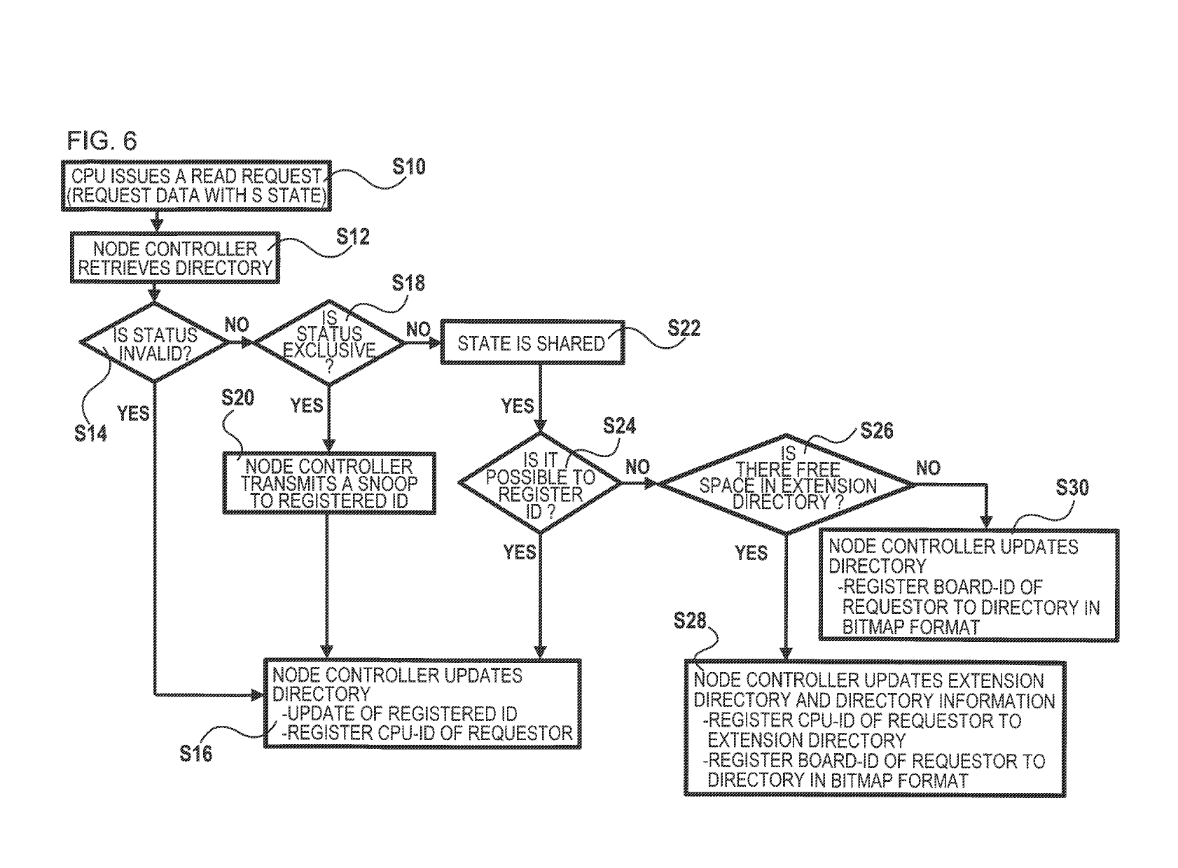

FIG. 6 is a flow diagram of the data request processing in the S state according to the embodiment. FIG. 6 illustrates a process flow diagram of the directory search in the node controller 2 when the CPU 3A (or 3B) requests the data in S (shared) state in the configuration described in FIG. 1 to FIG. 5.

(S10) The CPU 3A (or 3B) dispatches a read request in S state to the node controller 2.

(S12) In the node controller 2, the processing unit 28 receives the read request via the CPU interface circuit 26. The processing unit 28 searches the directory 22 in the node controller 2 by using a read address contained in the read request.

(S14) The processing unit 28 refers to the status field 22-3 of the entries in the directory 22 by the read address, and identifies the information in the status field 22-3. When the status field 22-3 indicates the invalid state (I state), any CPU does not have the requested data. That is, it is a state that any CPU does not require the data of the read address. When the status is determined as invalid state, the processing unit 28 proceeds to step S16.

(S16) The processing unit 28 in the node controller 2 registers the CPU-ID of the CPU that dispatched the request (here, called to the requestor) and the status (S state) to the directory 22.

(S18) The processing unit 28 determines whether the state of the requested data is the exclusive state (E state) by a result of reference to the status field 22-3 of the directory field 22.

(S20) The processing unit 28, when the status is determined to the E state, transmits a snoop to the CPU of the CPU-ID that is registered in the CPU-ID fields 22-4, 22-5 in the directory 22 via the external node interface circuit 20. Snoop transmission requests to change the state of the data to the CPU of CPU-ID which has been registered. Then, the process proceeds to step S16, and the processing unit 28 registers the CPU-ID of the CPU that dispatched the request to the directory 22.

(S22) The processing unit 28 determines whether the state of the requested data is the shared state (S state) by a result of reference to the status field 22-3 of the directory field 22.

(S24) The processing unit 28, when the status is determined to the S state, judges whether the CPU-ID can be registered in the directory 22. As described above, the entry of the A-type in the directory 22 can be registered only two CPU-IDs. The processing unit 28 determines that the CPU-ID can be registered, when the detailed information can be stored in the directory 22 (the format A-Type in FIG. 4) and the CPU-ID which has been registered is one. The processing unit 28, when it is determined that the CPU-ID can be registered, proceeds the step S16 and registers the CPU-ID of the requester to the directory 22.

(S26) The processing unit 28, when it is determined not to register the CPU-ID, can not store the detailed information in the directory 22. That is, the entry of A-type in the directory 22 already stored two CPU-IDs. Or the entry format is already changed to a B-Type. The processing unit 28, when it is determined that the CPU-ID can not be registered, determines whether there is a space in the extension directory 24.

(S28) When the processing unit 28 determines that there is free space in the extension directory 24, the processing unit 28 registers the CPU-ID of the requestor to the extension directory 24 in the form of a bitmap. In addition, the processing unit 28 registers the board ID of the requester CPU to the entry of B-Type in the directory 22 in the bitmap format. In this case, when it is necessary to change the entry in the directory 22 from A-Type to B-Type, the processing unit 28 updates the format type 22-1 to B-Type and the status 22-3 to the shared state in the directory 22.

(S30) The processing unit 28, when it is determined there is no free space in the extension directory 24, registers the board ID of the requester CPU to the entry of the B-Type in the directory 22 in the bitmap format.

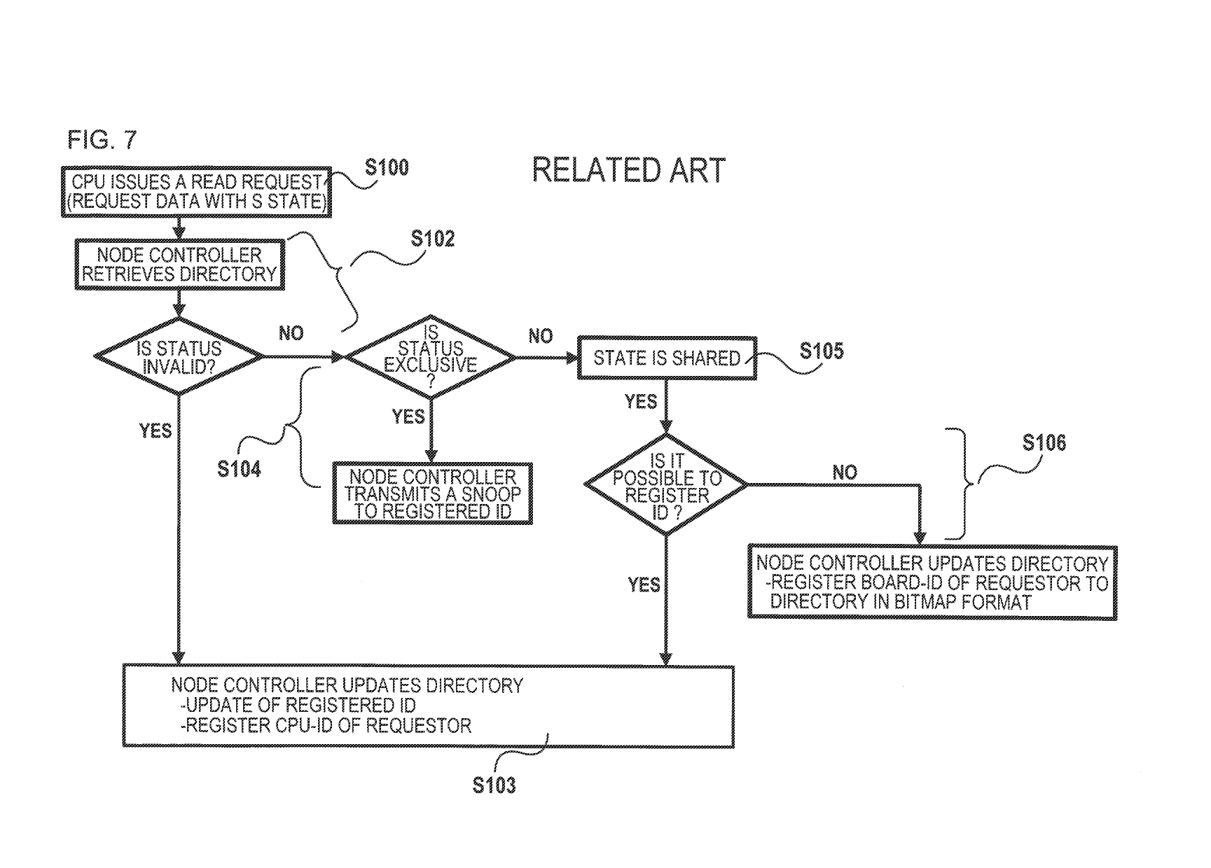

FIG. 7 is a flow diagram of the data request processing of a comparative example to FIG. 6. FIG. 7 illustrates a flow diagram of directory searching process in the node controller 2 when the CPU 3A (or 3B) dispatches the data request (read request) in S (shared) state in the case of not providing the extension directory 24.

As illustrated by FIG. 7, the CPU 3A (or 3B) dispatches a read request in S state to the node controller 2 (S100). The processing unit 28 in the node controller 2 receives the read request via the CPU interface circuit 26. The processing unit 28 searches the directory 22 in the node controller 2 by using a read address contained in the read request. The processing unit 28 refers to the status field 22-3 of the entries in the directory 22 by the read address, and identifies the information in the status field 22-3. When the status field 22-3 indicates the invalid state (I state), the processing unit 28 proceeds to step S103 (S102).

The processing unit 28 in the node controller 2 registers the CPU-ID of the CPU that dispatched the request and the status (S state) to the directory 22 (S103). The processing unit 28 determines whether the state of the requested data is the exclusive state (E state) by a result of reference to the status field 22-3 of the directory field 22. The processing unit 28, when the status is determined to the E state, transmits a snoop to the CPU of the CPU-ID that is registered in the CPU-ID fields 22-4, 22-5 in the directory 22 via the external node interface circuit 20 (S104). Then, the process proceeds to step S103, and the processing unit 28 registers the CPU-ID of the CPU that dispatched the request to the directory 22.

The processing unit 28 determines whether the state of the requested data is the shared state (S state) by a result of reference to the status field 22-3 of the directory field 22 (S105). The processing unit 28, when the status is determined to the S state, judges whether the CPU-ID can be registered in the directory 22. The processing unit 28, when it is determined that the CPU-ID can be registered, proceeds the step S103 and registers the CPU-ID of the requester to the directory 22. The processing unit 28, when it is determined that the CPU-ID can not be registered, registers the CPU-ID of the requester to the entry of B-Type in the directory 22 in the bitmap format. In this case, when it is necessary to change the entry in the directory 22 from A-Type to B-Type, the processing unit 28 updates the format type 22-1 to B-Type and the status 22-3 to the shared state in the directory 22 (S106).

In this way, in the embodiment, the extension directory 24 with a different format from the directory 22 is provided only using the S state. And the requester CPU-ID is registered to the expansion directory 24 in the bitmap format. Therefore, it is possible to identify the CPU with the S state with a minimum increase in the capacity of the directory even though increasing the number of the CPU that is installed in the information processing system.

(Data Request Processing in the E State)

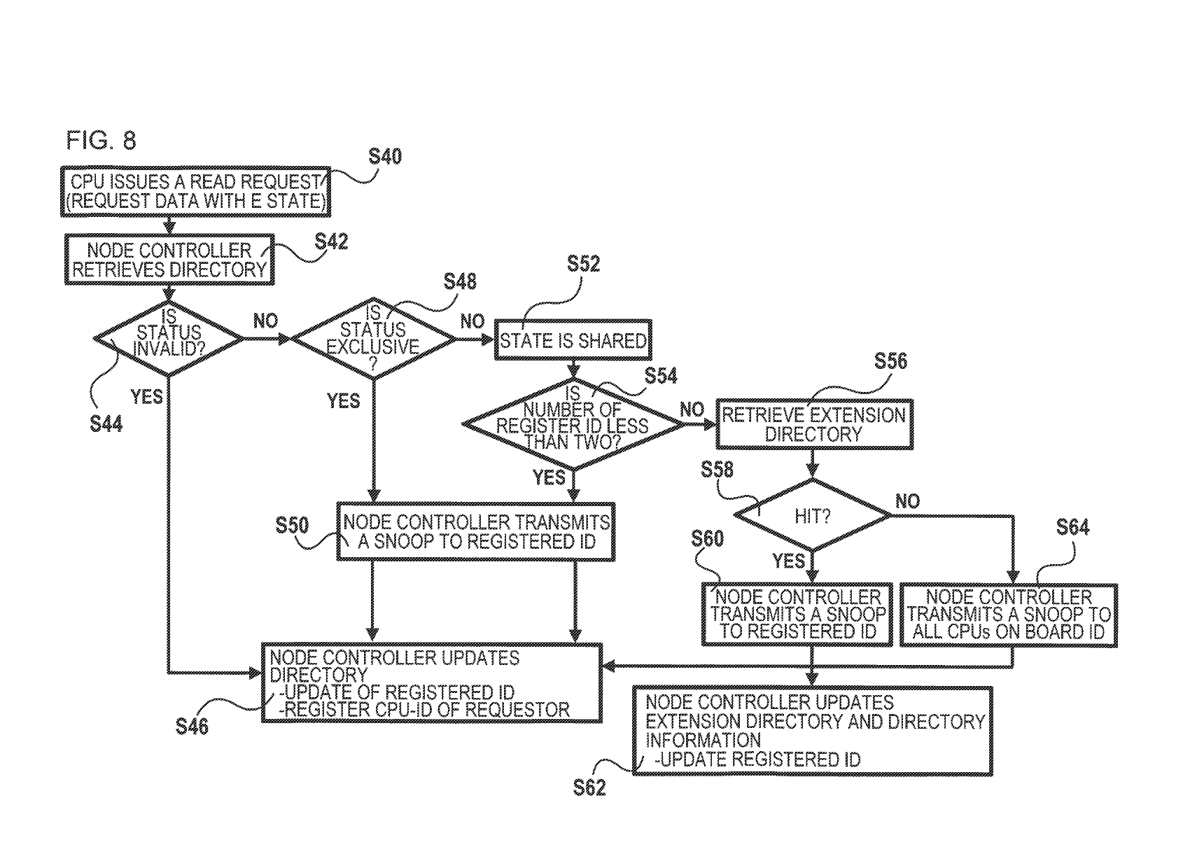

FIG. 8 is a flow diagram of the data request processing in E state according to the embodiment. FIG. 8 illustrates a process flow diagram of the directory search in the node controller 2 when the CPU 3A (or 3B) requests the data in E (Exclusive) state in the configuration described in FIG. 1 to FIG. 5.

(S40) The CPU 3A (or 3B) dispatches a read request in E state to the node controller 2.

(S42) In the node controller 2, the processing unit 28 receives the read request via the CPU interface circuit 26. The processing unit 28 searches the directory 22 in the node controller 2 by using a read address contained in the read request.

(S44) The processing unit 28 refers to the status field 22-3 of the entries in the directory 22 by the read address, and identifies the information in the status field 22-3. When the status field 22-3 indicates the invalid state (I state), any CPU does not have the requested data. When the status is determined as I state, the processing unit 28 proceeds to step S46.

(S46) The processing unit 28 in the node controller 2 registers the CPU-ID of the CPU that dispatched the request (here, called to the requestor) and the status (E state) to the directory 22.

(S48) The processing unit 28 determines whether the state of the requested data is the exclusive state (E state) by a result of reference to the status field 22-3 of the directory field 22.

(S50) The processing unit 28, when the status is determined to the E state, transmits a snoop to the CPU of the CPU-ID that is registered in the CPU-ID fields 22-4, 22-5 in the directory 22 via the external node interface circuit 20. Snoop transmission requests to change the state of the data to the CPU of

CPU-ID which has been registered. Then, the process proceeds to step S46, and the processing unit 28 registers the CPU-ID of the CPU that dispatched the request to the directory 22.

(S52) The processing unit 28 determines whether the state of the requested data is the shared state (S state) by a result of reference to the status field 22-3 of the directory field 22.

(S54) The processing unit 28, when the status is determined to the S state, judges whether the CPU-ID which has been registered in the directory 22 is less than two. As described above, the entry of the A-type in the directory 22 can be registered only two CPU-IDs. When the processing unit 28 determines that the CPU-ID which has been registered is less than two, the processing unit 28 transmits the snoop to the CPU of the CPU-ID that is registered in the CPU-ID fields 22-4, 22-5 in the directory 22 via the external node interface circuit 20. Then, the process proceeds to step S46, and the processing unit 28 updates the directory 22. That is, when single CPU-ID is registered in the directory 22, the processing unit 28 registers the CPU-ID of the CPU that dispatched the request to the directory 22. And when two CPU-IDs are registered in the directory 22, the processing unit 28 updates the entry in the directory 22 from the A-type to the B-type. That is, the processing unit 28 updates the format type field 22-1 to B-type and the status field to E state and registers a first board ID which mounts the CPU of the CPU-ID that has been already registered and a second board ID which mounts the CPU of CPU-ID to register at a present time in the directory 22 in the form of bitmap.

(S56) The processing unit 28, when it is determined that the CPU-ID, which has been registered, is not less than two, searches the extension directory 24 by the read address.

(S58) The processing unit 28 determines whether or not corresponding address to the read address of the request exists in the address field 24-2 of the extension directory 24 (called as HIT determination).

(S60) The processing unit 28, when determining that the corresponding address to the read address of the request exists in the address field 24-2 of the extension directory 24 (the HIT determination), transmits a snoop to the CPU of the CPU-ID that is registered in the bitmap field 24-4 of the CPU-ID in the extension directory 24 via the external node interface circuit 20.

(S62) After the processing unit 28 transmits the snoop, the processing unit 28 registers the CPU-ID of the requester to the bitmap field 24-4 of the CPU-ID in the extension directory 24 in the form of bitmap. In addition, the processing unit 28 registers the board ID of the CPU-ID of the requester to the entry of the B-type in the directory 22 in the form of bitmap. Further, the processing unit 28 updates the status field 22-6 in the directory 22 to E-state.

(S64) The processing unit 28, when determining that the corresponding address to the read address of the request does not exist in the address field 24-2 of the extension directory 24, transmits the snoop to the board of the board-ID that is registered in the entry of the B-type in the directory 22 via the external node interface circuit 20. And the processing unit 28 registers the board ID of the CPU-ID of the requester to the entry of the B-type in the directory 22 in the form of bitmap and updates the status field 22-6 in the directory 22 to E-state.

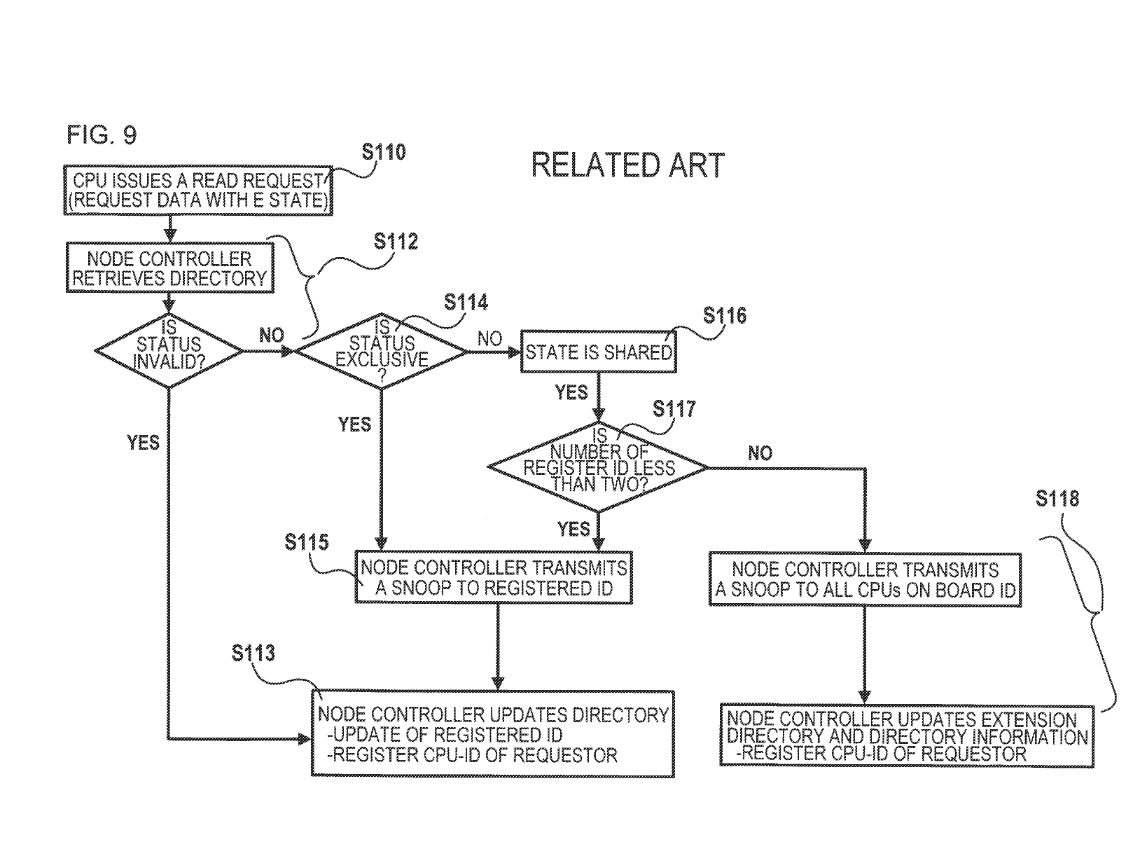

FIG. 9 is a flow diagram of the data request processing in E state of the comparative example of FIG. 8. FIG. 9 illustrates a flow diagram of directory searching process in the node controller 2 when the CPU 3A (or 3B) dispatches the data request (read request) in E (exclusive) state in the case of not providing the extension directory 24.

The CPU 3A (or 3B) dispatches a read request in E state to the node controller 2 (S110). The processing unit 28 searches the directory 22 in the node controller 2 by using a read address contained in the read request. The processing unit 28 determines whether the status field 22-3 of the entries in the directory 22 by the read address indicates the invalid state (I state) (S112). When the status is determined as I state, the processing unit 28 proceeds to step S113 and registers the CPU-ID of the CPU that dispatched the request and the status (E state) to the directory 22 (S113).

The processing unit 28 determines whether the state of the requested data is the exclusive state (E state) by a result of reference to the status field 22-3 of the directory field 22 (S114). The processing unit 28, when the status is determined to the E state, transmits a snoop to the CPU of the CPU-ID that is registered in the CPU-ID fields 22-4, 22-5 in the directory 22 via the external node interface circuit 20. The snoop transmission requests to change the state of the data to the CPU of CPU-ID which has been registered. Then, the process proceeds to step S113, and the processing unit 28 registers the CPU-ID of the CPU that dispatched the request to the directory 22 (S115).

The processing unit 28 determines whether the state of the requested data is the shared state (S state) by a result of reference to the status field 22-3 of the directory field 22 (S116). The processing unit 28, when the status is determined to the S state, judges whether the CPU-ID which has been registered in the directory 22 is less than two (S117). When the processing unit 28 determines that the CPU-ID which has been registered is less than two, the processing unit 28 transmits the snoop to the CPU of the CPU-ID that is registered in the CPU-ID fields 22-4, 22-5 in the directory 22 via the external node interface circuit 20 (S115). Then, the process proceeds to step S113, and the processing unit 28 updates the directory 22. That is, when single CPU-ID is registered in the directory 22, the processing unit 28 registers the CPU-ID of the CPU that dispatched the request to the directory 22. And when two CPU-IDs are registered in the directory 22, the processing unit 28 updates the entry in the directory 22 from the A-type to the B-type. That is, the processing unit 28 updates the format type field 22-1 to B-type and the status field to E state and registers a first board ID which mounts the CPU of the CPU-ID that has been already registered and a second board ID which mounts the CPU of CPU-ID to register at a present time in the directory 22 in the form of bitmap (S113).

The processing unit 28, when it is determined that the CPU-ID, which has been registered, is not less than two, transmits the snoop to the CPU or the board that is registered in the bitmap field 22-7 of the board-ID in the entry of the B-type in the directory 22 via the external node interface circuit 20. And the processing unit 28 registers the CPU-ID of the requester or the board ID to the entry of the B-type in the directory 22 in the form of bitmap, and updates the status field 22-6 in the directory 22 to E-state (S118).

In this way, in the embodiment, the extension directory 24 with a different format from the directory 22 is provided only using the S state. And the requester CPU-ID is registered to the expansion directory 24 in the bitmap format. Therefore, it is possible to identify the CPU with the S state with a minimum increase in the capacity of the directory even though increasing the number of the CPU that is installed in the information processing system.

Therefore, it is possible to focus the snoop destination and to reduce traffic, even though the cache shared memories 4A, 4B in the system board (node) 1-1˜1-n are used as a shared cache memory. In particular, it is possible to identify the CPU of snoop when issuing the request and to reduce traffic even though increasing the CPU and node that holds the data in the S state. Thereby, it contributes to improved performance.

### Second Embodiment of the Information Processing System

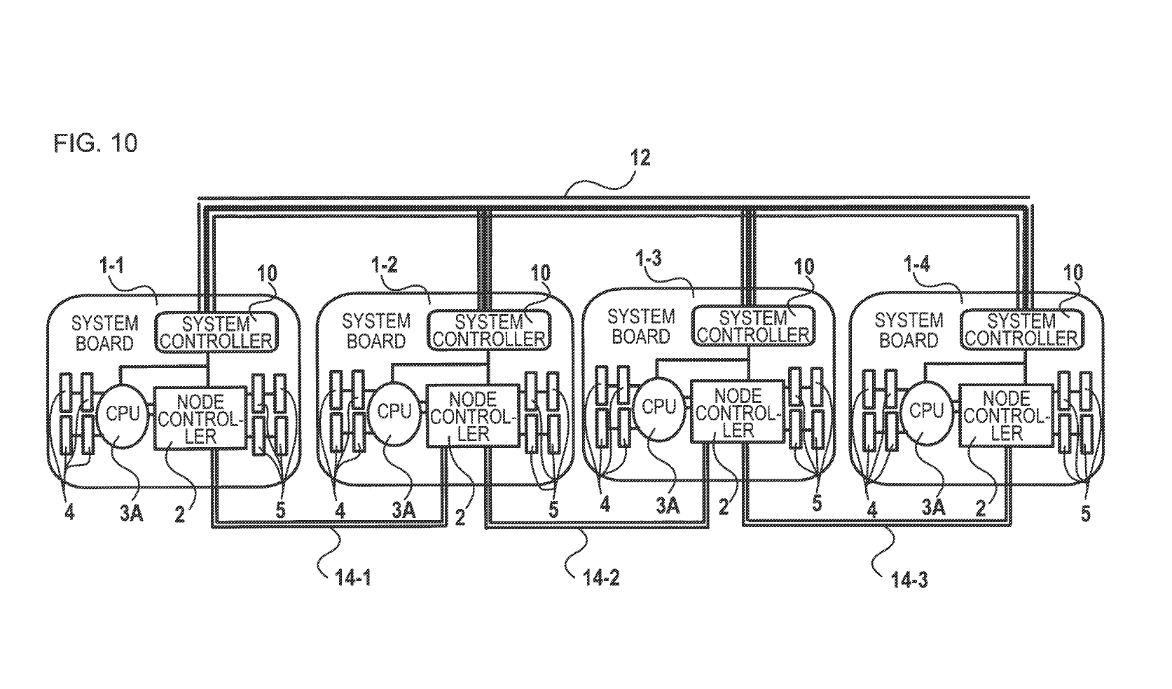

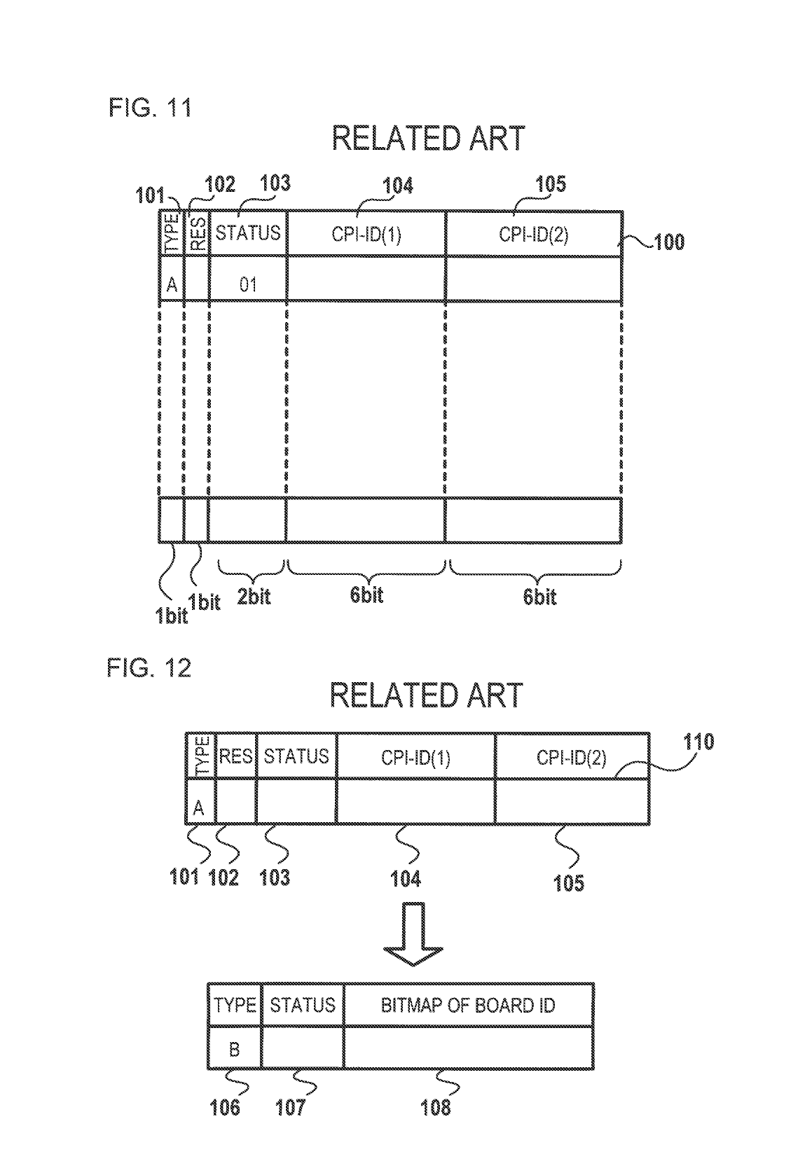

FIG.10 is a block diagram of an information processing system according to a second embodiment. In FIG. 10, the same elements as those described in FIG.1 to FIG. 5 have been denoted by the same symbols. FIG. 10 also illustrates an example of the information processing system in which a plurality of system boards have been concatenated.

As depicted by FIG. 10, the information processing system has a plurality (here, 4) of system boards (nodes) 1-1 to 1-4. Each of the system boards 1-1˜1-4 includes one or more CPU 3A, a first memory 4 connected to the CPU 3A, a node controller 2 connected to the CPU 3A, a second memory 5 connected to the node controller 2 and a system controller 10 which is connected to the CPU 3A and the node controller 2.

The first memory 4 constitutes the L2 cache memory. The second memory 5 constitutes the L3 cache memory. The first and second memories 4 and 5 may be used DIMM (Dual Inline Memory Module), for example. The node controller 2 performs communication between the system boards 1-1 to 1-4. In this example, the node controller 2 on the first system board 1-1 connects to the node controller 2 on the second system board 1-1 through a first communication path 14-1. In addition, the node controller 2 on the second system board 1-2 connects to the node controller 2 on the third system board 1-3 through a second communication path 14-2. Below, in the same way, the node controller 2 on the third system board 1-3 connects to the node controller 2 on the fourth system board 1-4 via a third communication path 14-3.

The system controller 10 performs a setting of status and monitoring of status of circuits (the CPU, the memory, etc.) on each of the system boards 1-1˜1-4. The system controller 10 provided to each of the system boards 1-1˜1-4 connects each other via the management bus 12. Furthermore, each system controller 10 notifies the operational status of each system boards and monitors the status of the other system boards via the management bus 12.

Further, the node controller 2 includes the directory 22 and the extension directory 24 in a memory space including the additional cache memory 5, as same as the configuration in FIG. 3 to FIG. 5. In the second embodiment, since the second memory 5 is constituted by the additional memory, and the second memory 5 is provided to the node controller 2, it is possible to easily expand the cache memory of the CPU 3A.

Further, since the system controller 10 is provided to each of the system boards 1-1 to 1-4, as compared to the first embodiment, it is possible to reduce the load on the system controller. It is possible to focus the snoop destination in the shared state and reduce the traffic even in the information processing system in which expansion of the cache memory is easy, similarly to the first embodiment.

### Other Embodiments

In the embodiment described above, single node has single system board. However, single node may has a plurality of system boards and a plurality of nodes may has single system board. Although it is described that the number of the CPUs which equipped with the system board is two, three or more CPUs may be mounted on single system board.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention has been described in detail, it should be understood that the various changes, substitutions, and alterations could be made hereto without departing from the spirit and scope of the invention.

What is claimed is:

1. An information processing system connected to a plurality of nodes,
each of said plurality of nodes comprising:
at least one arithmetic processing unit, a cache memory that stores data to be used by the arithmetic processing unit, and
a node controller that searches a directory which stores status information whether data stored in the cache memory has been held the cache memory of an other node and data that identifies the other node and transmits a snoop to the other node in response to a data request from the arithmetic processing unit;
wherein the directory in the node controller comprises:
a first directory that stores status information whether data stored in the cache memory has been held the cache memory of the other node and data that identifies the other node; and
a second directory which stores information that identify a shared node of a shared state of which the data stored in the cache memory has been held the cache memory of the other node.

2. The information processing system according to claim 1, wherein the node controller searches the first directory in the response to the data request from the arithmetic processing unit, searches the second directory when determining that the other node to transmit the snoop can not be identified from the first directory, and transmits the snoop to the other node which is identified from a search result of the second directory.

3. The information processing system according to claim 1, wherein the node controller determines whether a node identifier of the arithmetic processing unit can be stored in the first directory in response to the data request from the arithmetic processing unit, stores the node identifier of the arithmetic processing unit in the first directory when determining that the node identifier of the arithmetic processing unit can be stored in the first directory, and stores the node identifier of the arithmetic processing unit in the second directory when determining that the node identifier of the arithmetic processing unit can not be stored in the first directory.

4. The information processing system according to claim 2, wherein the node controller determines whether there is a free space in the second directory when determining that the node identifier of the arithmetic processing unit can not be stored in the first directory, stores the node identifier of the arithmetic processing unit in the second directory when determining there is the free space in the second directory, and changes an entry format of the first directory and stores the node identifier of the arithmetic processing unit in the first directory in bitmap format when determining there is not the free space in the second directory.

5. The information processing system according to claim 2, wherein the node controller searches the second directory in response to the data request with an exclusive state from the arithmetic processing unit, identifies the other node to transmit the snoop from the second directory, and transmits the snoop to the other node which is identified.

6. The information processing system according to claim 1, wherein the node has a plurality of the arithmetic processing unit, and
wherein the first directory stores the status information whether the data stored in the cache memory has been held the cache memory of the arithmetic processing unit in the other node and data that identifies the arithmetic processing unit of the other node; and
the second directory stores information that identify the arithmetic processing unit of the other node of which the data is the shared state.

7. The information processing system according to claim 1, wherein the first directory comprises:
a first entry format that stores the status information whether the data stored in the cache memory has been held the cache memory of the other node and data that identifies the other node; and
a second entry format that stores the status information whether the data stored in the cache memory has been held the cache memory of the other node and data that identifies the other node in a form of bitmap, and wherein
the second directory which stores information that identify the other node of which the data is the shared state in a form of bitmap.

8. The information processing system according to claim 1, wherein the first directory stores the status information that the stored data in the cache memory indicates one of the shared state which the data has been stored in the cache memory of the other node, and an exclusive state which the date in the cache memory is designated to an exclusive.
